(19) United States
(12) Patent Application Publication
(10) Pub. No.: US 2007/0154164 A1
(43) Pub. Date: Jul. 5, 2007

(54) CONVERTING A STILL IMAGE IN A SLIDE SHOW TO A PLURALITY OF VIDEO FRAME IMAGES

(76) Inventors: Samson J. LIU, Palo Alto, CA (US); Peng Wu, Palo Alto, CA (US); Gabriel B. Beged-Dov, Corvallis, OR (US); Joseph McCrossan, Burbank, CA (US); Paul A. Boerger, Fort Collins, CO (US); Tomoyuki Okada, Nara (JP)

Correspondence Address: HEWLETT-PACKARD COMPANY;Intellectual Property Adminstration, P.O. Box 272400, Ft. Collins, CO, 80527-2400, US

(21) Appl. No.: 11/466,251

(22) Filed: Aug. 22, 2006

Related U.S. Application Data
(63) Continuation of application No. 11/327,146, filed on Jan. 6, 2006, now abandoned.
(60) Provisional application No. 60/643,659, filed on Jan. 12, 2005.

(51) Int. Cl. H04N 5/93

(52) U.S. Cl. 386/52

(57) ABSTRACT

A method comprises generating still images for a slide show, converting at least one of the still images to a plurality of video frame images; and implementing a visual effect on at least one of the plurality of video frame images.

### CROSS-REFERENCE TO RELATED APPLICATIONS

This application is a continuation application and claims priority from copending U.S. patent application Ser. No. 11/327,146, filed on Jan. 6, 2006, which is hereby incorporated by reference herein.

The present invention claims priority to, and incorporates by reference, provisional application Ser. No. 60/643,659, filed Jan. 12, 2005.

### BACKGROUND

Electronic “slide shows” comprise a valuable mechanism for conveying information. Software exists that permits a user to create individual slides (termed generically herein as “still images”) to include within a slide show to be shown on a display in a prescribed order Some software permits special effects to be implemented during presentation of the slideshow. Some effects (e.g., region scrolling, zoom in/out) are intended to be applied to a single frame of the slide show, while other effects (e.g., wipe, fade in/out) are to be applied to transitions from one still frame to the next. Implementing special effects during creation of the slide show depends on the special effects capability of the playback system—different playback systems are capable of implementing different types of special effects. Thus, for example, an existing optical disc player may not be readily usable to implement special effects invented after manufacturing of the disc player.

### BRIEF DESCRIPTION OF THE DRAWINGS

For a detailed description of exemplary embodiments of the invention, reference will now be made to the accompanying drawings in which:

FIG. 1 shows a system in accordance with an illustrative embodiment of the invention;

FIG. 2 illustrates a slide show playback system;

FIG. 3 shows a method embodiment;

FIG. 4 illustrates the effect of the method embodiment on an exemplary slideshow; and

FIG. 5 illustrates an exemplary association of an audio stream with a video stream.

### NOTATION AND NOMENCLATURE

Certain terms are used throughout the following description and claims to refer to particular system components As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

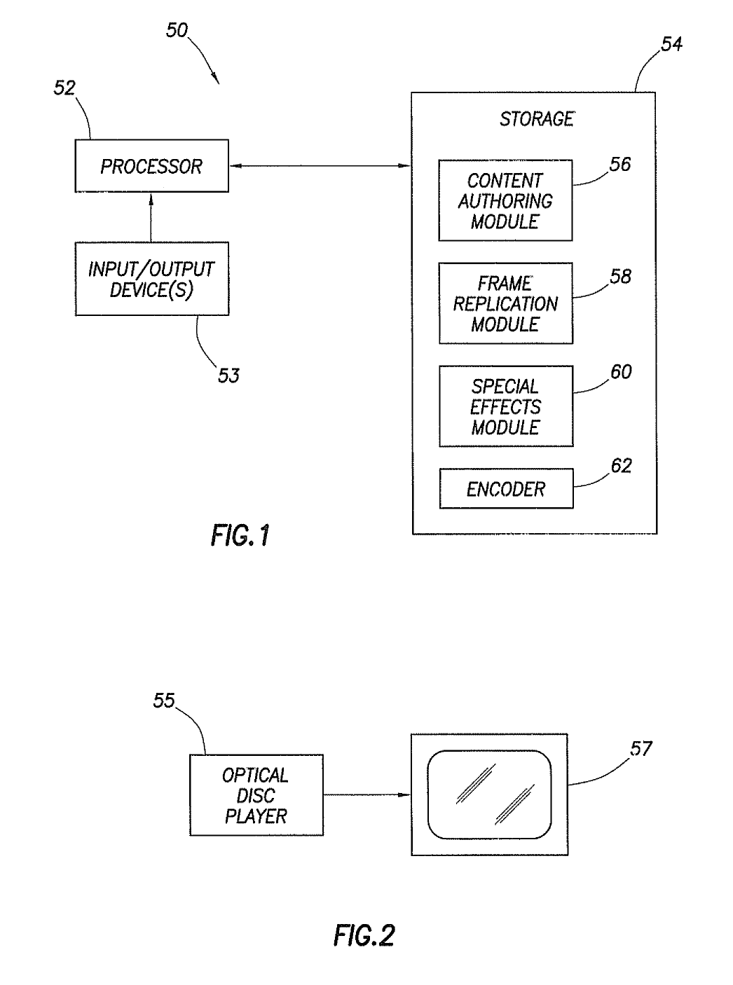

FIG. 1 shows an illustrative embodiment of a system 50 comprising a processor 52, storage 54, and one or more input and/or output devices 53. The processor 52 can be any suitable processor for executing software instructions. The input/output devices 53 may comprise an input device such as a keyboard or mouse and an output device such as a display. The storage 54 may be implemented as a combination of volatile and/or non-volatile storage such as random access memory, read-only memory, hard disk drive, etc. In the embodiment of FIG. 1, the storage 54 contains software that can be executed by processor 52. The software comprises a content authoring module 56, a frame replication module 58, a special effects module 60, and an encoder 62. The various modules 56-62 may comprise modules within a common software application or comprise individual software applications. The various modules are executed by the processor 52 at the direction of a user of the system 50 using input/output devices 53 to create a slide show as described herein.

The software modules 56-62 cause the processor to perform any one or more of the actions described below to create a slide show in accordance with an illustrative embodiment of the invention. The term “slide show” is broadly used to refer to any sequence of images to be displayed on a playback system, such as that shown in FIG. 2. In FIG. 2 an optical disc player 55 operatively couples to a display 57. The display 57 may comprise a television, computer monitor or other suitable display device. The optical disc player 55 receives an optical disc on which the slide show generated as described herein has been stored. The optical disc player 55 then plays back the slide show on the display 57. The playback system may also comprise one or more speakers to play audio associated with the slide show.

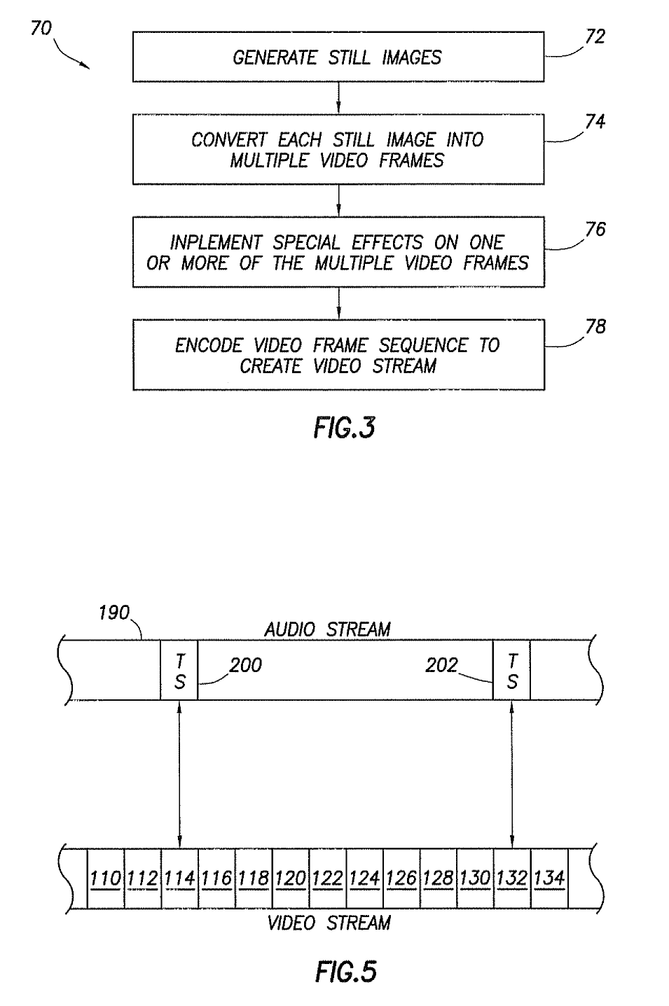

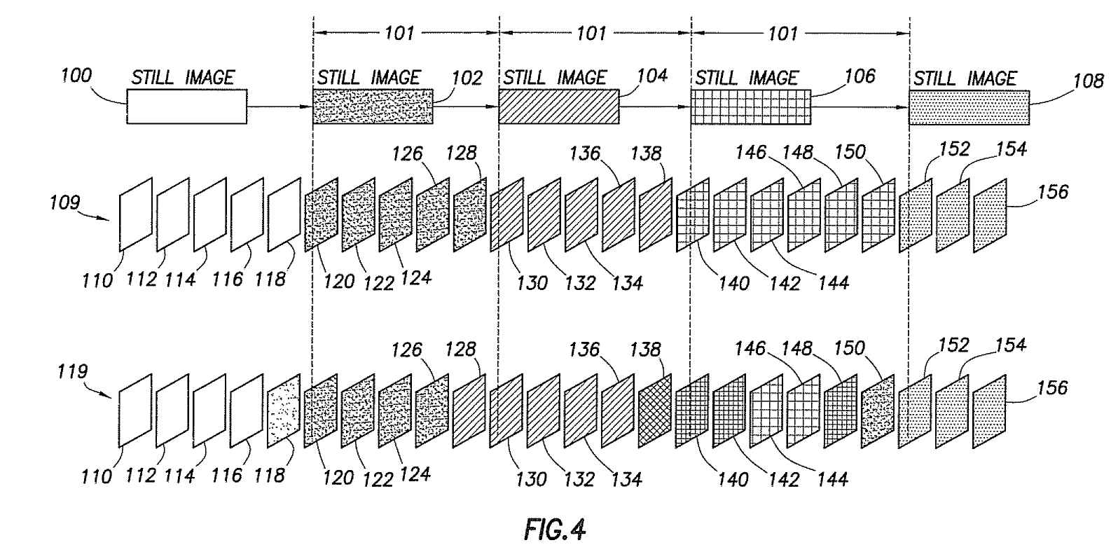

FIGS. 3 and 4 will now be discussed to illustrate the creation of a slide show in accordance with embodiments of the invention. FIG. 3 shows a method 70 comprising actions 72-78. Action 72 comprises generating still images. This action may be performed by content authoring module 56. In the example of FIG. 4, this action results in a series of still images 100, 102, 104, 106, and 108. Each still image broadly represents a single slide within a slide show. As shown, each still image 100-108 includes different types of shading to depict that each still image may comprise different information in the slide show. Each still image may comprise text and/or graphics as desired. Each still image may be provided from any of a variety of sources such as digital cameras, scanned photos, etc.

Some types of slide shows are referred to as “timebased” slide shows in that each slide is displayed for a finite amount of time typically specified by the user. As such, the playback system (e.g., the optical disc player 55 of FIG. 2) shows each slide for the prescribed time period, then switches to the next slide, and so on. In FIG. 4, the time period for each still image to be displayed is designated by reference numeral 101. The playback system implements a particular video frame rate that refers to the number of video frames that are displayed per second. An exemplary frame rate is 30 frames per second.

In accordance with an exemplary embodiment of the invention, each still image 100-108 is converted (action 74) into multiple video frame images. Further, the conversion of still images to multiple video frames is in accordance with the frame rate of the applicable playback. In at least one embodiment, the conversion process comprises replicating the associated still image enough times to create a video stream that can be played through the playback system for the desired period of time. The number of the plurality of video frame images that is produced while converting the still images is a function of a frame rate and an amount of time that the still image is to be shown on the display. If, for example, the frame rate is 30 frames per second and the author of the slide show intends for a particular still image to be displayed for 5 seconds, then the conversion process of action 74 will entail replicating the still image 149 times to thereby create 150 identical frames of that still image. The result of action 74 is depicted at 109 in FIG. 4. As shown, still image 100 is replicated as video frames 110-118. Still image 102 is replicated as video frames 120-128. Still image 104 is replicated as video frames 130-138. Still image 106 is replicated as video frames 140-150, while still image 108 is replicated as video frames 152-156. Of course the number of replicated frames may vary from that shown in FIG. 4 and, in general, will depend on the frame rate as explained above.

At 76 in FIG. 3, method 70 comprises implementing special effects on one or more of the replicated video frames. The special effects can comprise any effects now known or later developed such as region scrolling, zoom in/out, wipe, fade in/out, etc. At 119, FIG. 4 illustrates fading into the next still image. For example, video frames 118-122 comprise varying degrees of alteration to fade into the target still image 102 as depicted at frames 124 and 126. The same fade-in process is also performed for frames 128-130, frames 138-142, and frames 148-150. The type of special effect is selected by the author of the slide show and can be varied from still image to still image. Moreover, special effects are imposed directly on the replicated video frames. The generation of the multiple repeated frames and the implementation of the special effects on those frames can be performed in a single operation, which may simplify implementation. Frames with special effects may be referred to as “special effect frames.” As such, meta-data (which might otherwise be used to specify special effects) is generally not needed and thus may not be included in at least some embodiments. Further, the playback system need not be constructed to interpret meta-data to implement special effects. Instead, the playback system need only play the video stream created in accordance with method 70.

Method 70 also comprises action 78 which comprise encoding the video frame sequence to create a suitable video stream to be provided to the playback system (e.g., on an optical disc). The encoding process may comprise compression and other suitable techniques

The author of the slide show may desire to have an audio clip play along with the video presentation. The audio may or may not be synchronized to the video frames. Synchronized audio-video means that certain sections of audio are associated with certain still images. Each still image in the slide show has a predetermined presentation timing in a timebased slide show. Synchronized audio permits a user to skip back and forth between still images and have the desired audio segments play in accordance with the particular still images being displayed. Unsynchronized audio means that an audio stream plays while the slide show is being presented, but specific sections of audio are not associated with particular still images.

In accordance with embodiments of the present invention, audio can be included with the slide show, in some embodiments in a separate file, and can be synchronized or unsynchronized to the replicated video frames discussed above. FIG. 5 illustrates an audio stream 190 associated with the series of replicated video frames 110-134. One or more timestamps 200 and 202 are embedded within the audio stream 190 to synchronize to the video frames in the case in which synchronized audio is desired to include with slide show. In some embodiments, the audio stream 190 comprises a separate time stamp associated with each replicated video frame. In other embodiments, such as that depicted in FIG. 5, a time stamp is embedded in the audio stream for every n video frames. Time stamp 200 is mapped to video frame 114, while time stamp 202 is mapped to video frame 132. The value n can be set as desired and in the example of FIG. 5 is 10. Intermediate time values between the time stamps can be computed based on the embedded time stamps and the frame rate associated with the video stream. The special effects module 60 or the encoder 62 maps the audio stream's time stamps 200, 202 to the various associated video frames. This mapping ensures that the playback system plays the correct audio segment while displaying the video frames. Thus, the time stamps are used to associate audio segments with individual video frames, not just the still images from which the video frames were replicated.

Some slide shows are referred to as “browsable” slide shows in that each still image is displayed until a user of the playback system causes the slide show to advance (e.g., by activating a “next” or “back” control). Each still image scene comprises the group of frames that represents a still image (e.g., frames 120-128 in FIG. 4) and is referred as a “browsing unit.” In the case of video, each “browsing unit” contains all of the video frames, including replicated and special effect frames, associated with that scene. Thus, the navigation of browsable slide shows is from one browsing unit to another (i.e. from one scene to another). Each browsing unit can be a separate video bitstream file or a segment of a video bitstream (comprising, for example, the concatenation of multiple browsing units). Meta-data may be provided to define and describe each browsing unit. In a browsable slide show, the audio stream may not be synchronized to the various slides and thus the audio is continuously decoded and played, with loops if desired, separate from the decoding and playback of the video stream.

In a browsable slide show, each slide is potentially displayed for an indefinite period of time. That being the case, an issue arises as to which video frame(s) of the multiple replicated frames or special effect frames to jump into and to “hold” during the potentially indefinite time period. In accordance with an embodiment of the invention, the frame to jump into when the user advances a browsable slide show is predesignated by way of location pointers, or “entry marks,” which point to the beginning of a browsing unit. For example, if a browsable slide show is playing and is currently displaying and holding on frame 124 in FIG. 4 and the user advances the slide show, a location pointer could be used to point to frame 134 for the next browsing unit. The last frame in a browsing unit will be held indefinitely until a “next” or “previous” control command is issued. As such, the playback system advances to frame 134 and decodes and displays all the frames until the last frame of the browsing unit is reached, which is held until a navigation command is issued. In some embodiments, the location pointers point to specific portions of the compressed video stream. A decoder in the playback system begins decoding the compressed video stream from that point on. The frame to which the location pointer maps should be “independently” decodable (such as an “I-frame” in accordance with the MPEP protocol). This means that the playback system should be able to decode the identified frame. Some frames (e.g., P-frames and B-frames) may be decodable only based on the decoding of a prior frame. Such frames are not independently decodable.

In other embodiments related to browsable slide shows, a pair of pointers is used with regard to each scene, with or without special effects. A first pointer comprises a location pointer into the compressed video stream at which the playback system begins decoding and playing. A second pointer comprises a hold pointer at which point the playback system stops decoding and holds. With reference to FIG. 4, the first and second pointers may point to replicated frames 124 and 128, respectively (or portions of the compressed video stream associated with those frames). As such, the playback system will jump to frame 124, begin decoding from that frame on and stop at frame 128. The playback will hold on frame 128 until the user opts to advance to the next portion of the slide show. Reciprocal pointers can be implemented when reversing back through a slide show. Thus, embodiments of the invention comprise detecting a user's input to advance the slide show and using first and second pointers to begin to decode the slide show at a first video frame and hold the slide show at a second video frame.

In some embodiments of the invention, it may be desired to “shuffle” through the slide show jumping from one still image to another in an arbitrary order such as that desired by the viewer of the slide show. The desire to shuffle the slide show images is complicated in a system in which the slide show has been converted into a video stream with special effect frames as discussed above—the playback system generally begins decoding at the beginning of the video stream continues to the end either based on time or based on user input to advance the presentation. To implement shuffling, the playback order of the browsing units or scenes can be specified as desired. An embodiment of the invention comprises saving each sequence of replicated video frames for a particular still image as a separate file. For FIG. 4, for example, replicated frames 110-118 can be saved as one file. Frames 120-128 can be saved as another file and so on. The order of the playback of the various files can be specified as desired.

In another embodiment, pointers to a starting point for decoding each series of replicated frames for a still image can be mapped to such frames to provide a mechanism by which to shuffle. Then, the pointers can be listed in a desired to order to implement shuffling during playback of the slide show.

Thus, at least one embodiment of the invention comprises a method that comprises generating still images for a slide show, converting at least one of the still images to a plurality of video frame images, and encoding the plurality of video frame images to form a video stream representative of the slide show. The method further comprises implementing a visual effect on at least one of the plurality of video frame images. Converting the at least one of the still images comprises replicating the at least one of the still images multiple times to produce the plurality of video frame images. The method further comprises converting each of the still images to a plurality of video frame images. The method further comprises providing the plurality of video frame images corresponding to each still image as a file separate from files containing video frame images associated with other still images.

An associated system comprises a content authoring module to create still images for a slide show, a frame replication module to convert each of the still images into a plurality of video frame images, and an encoder that encodes the plurality of video frame images to form a video stream representative of the slide show. In such a system, the frame replication module replicates each of the still images a number of times that is a function of a frame rate associated with playback of the slide show.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
generating still images for a slide show;
converting at least one of said still images to a plurality of video frame images; and
implementing a visual effect on at least one of said plurality of video frame images.

2. The method of claim 1 wherein converting the at least one of said still images comprises replicating said at least one of said still images multiple times to produce said plurality of video frame images.

3. The method of claim 1 wherein converting the at least one of said still images comprises producing said plurality of video frame images in accordance with a frame rate of a video stream.

4. The method of claim 1 further comprising associating audio with said plurality of video frame images.

5. The method of claim 1 further comprising mapping a time stamp included in an audio stream with at least one video frame image.

6. The method of claim 1 further comprising associating a pointer with at least one video frame image, said pointer used when a user manually advances the slide show.

7. The method of claim 6 further comprising detecting a user's input to advance the slide show and beginning to decode said slide show at the video frame associated with the pointer.

8. The method of claim 1 further comprising associating a first pointer with a first video frame image and second pointer with a second video frame image.

9. A system, comprising:
a content authoring module to create still images for a slide show;
a frame replication module to convert each of said still images into a plurality of video frame images; and
a special effects module to implement a visual effect on at least one of said plurality of video frame images.

10. The system of claim 9 further comprising an encoder to encode said plurality of video frame images to form a video stream representative of said slide show.

11. The system of claim 9 wherein said frame replication module replicates, each said still images a number of times as a function of a frame rate associated with playback of said slide show.

12. The system of claim 9 wherein said frame replication module replicates, each of said still images a number of times that is a function of a frame rate associated with playback of said slide show and as function of a period of time for each still image to be displayed during playback of said slide show.

13. The system of claim 9 wherein a pointer is associated with at least one of said video frame images to permit a viewer of the slide show to manually advance the slide show.

14. The system of claim 9 wherein a plurality of pointers are each associated with a video frame image to permit a viewer of the slide show to manually advance the slide show.

15. A storage medium containing software that, when executed by a processor, causes the processor to:
generate still images for a slide show;
convert at least one of said still images to a plurality of video frame images; and
implement a visual effect on at least one of said plurality of video frame images.

16. The storage medium of claim 15 wherein the software causes the processor to convert the at least one of said still images by replicating said at least one of said still images multiple times to produce said plurality of video frame images.

17. The storage medium of claim 15 wherein the software causes the processor to convert the at least one of said still images by producing said plurality of video frame images in accordance with a frame rate of a video stream.

18. The storage medium of claim 15 wherein the software causes the processor to associate audio with said plurality of video frame images.

19. The storage medium of claim 15 wherein the software causes the processor to associate a pointer with at least one video frame image, said pointer used when a user manually advances the slide show.

20. The storage medium of claim 19 wherein the software causes the processor to detect a user's input to advance the slide show and begin to decode said slide show at the video frame associated with the pointer.
